(19) United States
(12) Patent Application Publication
(10) Pub. No.: US 2009/0234719 A1
(43) Pub. Date: Sep. 17, 2009

(54) METHOD TO DETERMINE INDIVIDUAL WORK EFFECTIVENESS

(76) Inventor: Ana Dvoredsky, Woodinville, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 12/047,500

(22) Filed: Mar. 13, 2008

(51) Int. Cl. G06Q 10/00

(52) U.S. Cl. 705/11

(57) ABSTRACT

A method to determine individual work effectiveness for a given event so that the user can determine whether the individual can continue to work. Event is defined as a situation where the individual's work effectiveness comes into question.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BRIEF SUMMARY OF THE INVENTION

Since the beginning of time, human resource managers have been trying to determine how to maximize the work effectiveness of human capital. Work effectiveness is defined as the measure of the human capital's ability to perform a given task efficiently and/or safely at a given time. Over time, as human resource managers have grown wiser and work has grown more technical based, human resource managers have realized that work effectiveness is limited by, among other things, how many hours human capital actually works.

For example, the medical community within the United States has initiated a re-examination of how it trains physicians. One area that has received significant attention is the extended work hours historically experienced by medical residents. In June of 2002 the Accreditation Council for Graduate Medical Education (ACGME) instituted work hour limitations for all resident training programs. There are three main components to these new rules: 1) limiting the work week to 80 hours, 2) limiting continuous time on duty to 24 hours (with 6 additional hours to complete all tasks) and 3) requiring 24 consecutive hours off out of every 7 days. The future will likely involve even further restrictions. Although standard limitations on work hours may make human resource managers and human capital feel better, it does nothing to make an individual determination of work effectiveness.

Information relevant to attempts to address this problem can be found in: Hursh, U.S. Pat. No. 7,207,938 (April 2007); Konop, US Pub. No. 2005/0154634 (July 2004); Balkin, U.S. Pat. No. 6,740,032 (May 2004); Hursh, U.S. Pat. No. 6,579,233 (June 2003); Villanova, U.S. Pat. No. 6,459,946 (October 2002); Tanaka, U.S. Pat. No. 5,615,138 (March 1997); Balkin, U.S. Pat. No. 6,743,167 (June 2004). However, each of these references suffers from one or more of the following disadvantages:
(1) assumes standard factors in determining an individual's work effectiveness;
(2) does not allow user to recalibrate individual's work effectiveness;
(3) does not allow for discretionary evaluation by the user.

As we know, work effectiveness is a function of many factors, including but not limited to, the human capital's level of fitness, previous tasks that he has performed; the task at hand that needs to be performed; how much non-interrupted sleep he has gotten, how much caffeine has been consumed; whether the individual went surfing prior to coming to work; among others. The object of the current invention is to provide the user with a system to evaluate work effectiveness which is a function of baseline data gathered for the particular human capital and the organization.

A further object of the current invention is to provide meaningful updates to the individual and organizational data related to work effectiveness as field data is gathered. Another object of the current invention is to allow human resources managers, for example, make a discretionary decision regarding an individual's work effectiveness.

### BRIEF SUMMARY OF THE INVENTION

The current method allows the user to determine an individual's work effectiveness for a given event so that the user can determine whether the individual can continue to work. Event is defined as a situation where the individual's work effectiveness comes into question.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a flow chart of Method to Determine Individual Work Effectiveness;

FIG. 2 is a flow chart of means to determine an individual profile;

FIG. 3 is a flow chart of means to determine an organizational profile.

### DETAILED DESCRIPTION OF THE INVENTION

The present invention is described more fully hereinafter with reference to the accompanying drawings, in which preferred embodiments of the invention are shown. This invention may, however, be embodied in many different forms and should not be construed as limited to the embodiments set for herein; rather, these embodiments are provided so that this disclosure will be thorough and complete and will fully convey the scope of the invention to those skilled in the art.

As will be appreciated by one skilled in the art, the present invention may be embodied as a method, data processing system, or computer program product. Accordingly, the present invention may take the form of an entirely hardware embodiment, and entirely software embodiment, or an embodiment combining hardware and software. The present invention may also take the form of a computer program product on a computer-usable storage medium having computer usable program code embodied in the medium. Any known or unknown suitable computer readable medium may be utilized including hard disks, CD-ROMs, optical storage devices, or magnetic storage devices, among others.

Computer program code for carrying out the present invention may be written in any known or unknown programming language. For example, computer program code may be written in an object oriented programming language such as Java or in a conventional procedural programming language such as the “C” programming language.

The programming code may execute entirely on the user's computer, as a stand alone software package; on a remote computer; or it may execute partly on the user's computer and partly on a remote computer. In the later scenario, the remote computer may be connected directly to the user's computer though a LAN, intranet or internet connection.

The invention may be implemented as software that may be resident on a stand-alone device such as a personal computer, a PAL device, a personal digital assistant, an e-book, or other handheld or wearable computing devices (incorporating Palm OS, Windows CE, EPOC, or future generations like code named products Razor from 3Com or Bluetooth from a consortium including IBM and Intel), or a specific purpose device having an application specific integrated circuit.

The present invention is described below with reference to flowchart illustrations of methods. It will be understood that each block of the flowchart illustrations, and combinations of blocks in the flowchart illustrations, can be implemented by computer program instructions.

Although prior art has attempted to determine some sort of standardized method to determine work effectiveness, those standardized methods fail for the simple reason that all human capital are not the same. The current method allows the user to determine an individual's work effectiveness for a given event so that the user can determine whether said individual can continue to work. Event is defined as a situation where an individual's work effectiveness comes into question.

This method can be applied to determine an individual's work effectiveness in any profession or work; for example, this method can be used to: (a)determine whether a physician who has been on call all night can safely perform surgery at 6:00 am; (b)determine whether a pilot who has flown a combat mission and has only three hours of sleep can safely perform another mission; (c) determine whether a truck driver who has had stimulants and has driven 500 miles in 8 hours time can safely drive another 100 miles in the following two hours; (d)determine whether an associate at a large law firm who has billed 70 hours of time over a week can efficiently write another patent.

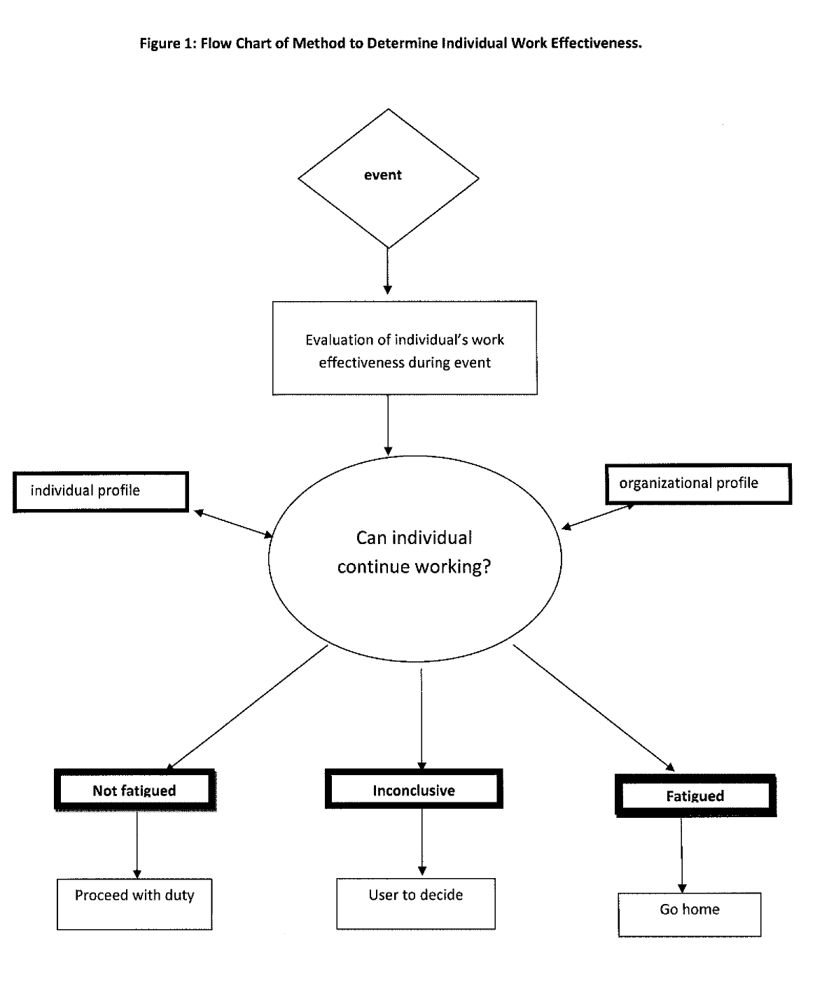

Referring to FIGS. 1, 2 and 3, this method is unique in that it is dependent on data gathered for both an individual and the organization to which the individual is a member. Further, the data is updated each time an event occurs; consequently, the data remains relevant as time goes on.

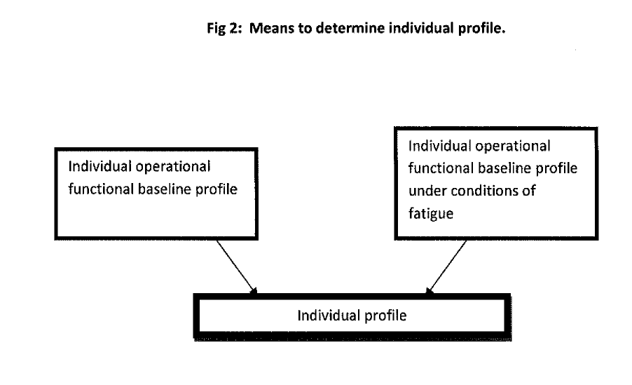

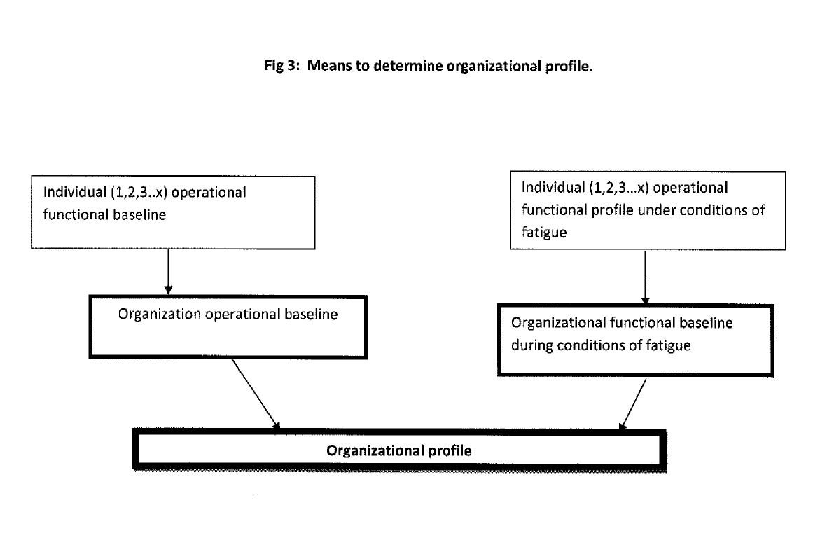

Referring to FIG. 2, the method comprises a means to determine an individual profile. The individual profile is a function of said individual's operational functional baseline and said individual's operational functional baseline during conditions of fatigue. Referring to FIG. 3, the method further comprises a means to determine an organizational profile. The organizational profile is a function of the individual profiles of each individual who is a member of the organization

Referring to FIG. 1, during an event the individual's work effectiveness is measured and compared to the individual profile and the organizational profile. If the comparison shows that the individual's work effectiveness is fatigued when compared to his baseline and the organizational profile, the individual will be taken off duty. If the comparison shows that the individual's work effectiveness is not fatigued when compared to his baseline and the organizational profile, he is allowed to continue work. If the comparison is inconclusive, the user makes a discretionary decision.

The work effectiveness measured during the event at issue is used to update the said individual profile and said organizational profile. Therefore, both said individual profile and said organizational profile are continuously evolving. Consequently, the data used for comparison remains accurate as the individual and the organization ages, for example.

What is claimed:

1. A method to determine an individual's work effectiveness comprising:
a means to determine said individual's profile;
a means to determine an organizational profile, where the organizational profile is a function of the individual profiles of each individual who is a member of the organization;
a means to evaluate said individual's work effectiveness during an event;
a means to compare said individual's work effectiveness during an event with said individual's profile and with said organizational profile;

2. the method of claim 1 where the means to determine said individual's profile comprises:
a means to determine said individual's operational functional baseline profile;
a means to determine said individual's operational functional baseline profile during conditions of fatigue;

3. the method of claim 1 where event is defined as a situation where said individual's work effectiveness comes into question;

4. the method of claim 1 where a means to compare said individual's work effectiveness with said individual's baseline profile and with said organizational profile shows that said individual is fatigued, said individual is not allowed to continue work;

5. the method of claim 1 where a means to compare said individual's work effectiveness with said individual's baseline profile and with said organizational profile shows that said individual is not fatigued, said individual is allowed to continue work;

6. the method of claim 1 where a means to compare said individual's work effectiveness with said individual's baseline profile and with said organizational profile shows that said individual is inconclusive, user makes discretionary evaluation;

7. the method of claim 1 where the means to determine said individual's baseline profile is updated to reflect the information from claims 4;

8. the method of claim 1 where the means to determine said individual's baseline profile is updated to reflect the information from claims 5;

9. the method of claim 1 where means to create an organizational profile is updated to reflect the information from claims 4;

10. the method of claim 1 where means to create an organizational profile is updated to reflect the information from claims 5.
